(19) United States
(12) Patent Application Publication
(10) Pub. No.: US 2026/0326380 A1
(43) Pub. Date: Oct. 22, 2026

(54) TRAPPED PARTICLE CLASSIFICATION IN ADDITIVE MANUFACTURING

(71) Applicant: Arizona Board of Regents on Behalf of the University of Arizona, Tucson, AZ (US)

(72) Inventors: Euan MCLEOD, Tucson, AZ (US); Natalie SHULTZ, Tucson, AZ (US)

(73) Assignee: Arizona Board of Regents on Behalf of the University of Arizona, Tucson, AZ (US)

(21) Appl. No.: 19/157,585

(22) PCT Filed: Feb. 20, 2024
(86) PCT No.: PCT/US24/16494

§ 371 Date: Aug. 18, 2025

Related U.S. Application Data
(60) Provisional application No. 63/446,587, filed on Feb. 17, 2023.
(60) Provisional application No. 63/626,360, filed on Jan. 29, 2024.

(51) Int. Cl. B29C 64/386; B29C 64/153; B33Y 10/00; B33Y 30/00; B33Y 50/00; G01N 15/0205; G01N 15/14; G01N 15/1429; G01N 15/1434

(52) U.S. Cl. CPC B29C 64/386; B29C 64/153; G01N 15/0211; G01N 15/1429; G01N 15/1434; B33Y 10/00; B33Y 30/00; B33Y 50/00; G01N 2015/1493

(57) ABSTRACT

A particle selection system for an additive manufacturing system includes an optical source; an objective lens arranged in an optical path of the optical source, the optical source having a sufficient power and the objective lens having a sufficient numerical aperture to provide an optical trap for particles of interest; a particle chamber arranged to intercept focused light from the objective lens such that the optical trap is formed within the chamber, the chamber being suitable to contain the particles of interest in a suspension therein; an optical detector arranged to receive light from the optical source after being scattered by at least one particle when held within the optical trap and to provide detection signals; and a processor arranged to receive the detection signals and configured to determine at least one of an absence or presence of particles of interest within the optical trap based on the detection signals.

### CROSS-REFERENCE OF RELATED APPLICATION

This application claims priority to U.S. Provisional Application No. 63/446,587 filed Feb. 17, 2023, and 63/626,360 filed Jan. 29, 2024; the entire contents of which are hereby incorporated by reference.

### FEDERAL FUNDING

This invention was made with government support under Grant Nos. HDTRA-11810044 awarded by Department of Defense; and 2045220 awarded by National Science Foundation. The government has certain rights in the invention.

### BACKGROUND

### 1. Technical Field

The field of currently claimed embodiments of this invention relates to systems and methods of classifying and trapping particles for additive manufacturing.

### 2. Discussion of Related Art

U.S. application Ser. No. 16/966,841 assigned to the same assignee as the current application and incorporated herein, provides systems and methods for optical positioning and linking (OPAL). That patent application describes embodiments that used optical tweezers to position micro and nanoscale building blocks that were linked together using biochemical linker molecules to assemble nanophotonic metamaterials and devices. OPAL offers the potential for particularly high resolution and multi-material integration compared to other existing 3D nanofabrication tools. Previously, OPAL was semi-automated in that while the positioning of the building blocks was automated via computer control, the loading of particles into the optical trap was not. It was done by the operator manually “fishing” for particles using the optical tweezer. There thus remains a need for improved systems and methods of classifying and trapping particles for additive manufacturing.

### SUMMARY

A particle selection system for an additive manufacturing system according to an embodiment of the current invention includes an optical source; an objective lens arranged in an optical path of the optical source, the optical source having a sufficient power and the objective lens having a sufficient numerical aperture to provide an optical trap for particles of interest; a particle chamber arranged to intercept focused light from the objective lens such that the optical trap is formed within the chamber, the chamber being suitable to contain the particles of interest in a suspension therein; an optical detector arranged to receive light from the optical source after being scattered by at least one particle when held within the optical trap and to provide detection signals; and a processor arranged to receive the detection signals, the processor being configured to determine at least one of an absence of particles of interest within the optical trap, a presence of a single particle of interest within the optical trap, or a presence of a plurality of particles of interest within the optical trap based on the detection signals. The detection signals have stochastic time variances due to Brownian motion of the particles of interest in suspension within the particle chamber, and the determination of the presence of the single particle or the presence of the plurality of particles is based on a dissimilarity of the stochastic time variance of the single particle relative to the plurality of particles.

An automated additive manufacturing system according to an embodiment of the current invention includes a particle supply system; and a particle selection system in fluid connection to the particle supply system. The particle selection system includes an optical source; an objective lens arranged in an optical path of the optical source, the optical source having a sufficient power and said objective lens having a sufficient numerical aperture to provide an optical trap for particles of interest; a particle chamber arranged to intercept focused light from the objective lens such that the optical trap is formed within the chamber, the chamber being suitable to receive the particles of interest from the fluid supply system and to contain the particles of interest in a suspension therein; an optical detector arranged to receive light from the optical source after being scattered by at least one particle when held within the optical trap and to provide detection signals; and a processor arranged to receive the detection signals, the processor being configured to determine at least one of an absence of particles of interest within the optical trap, a presence of a single particle of interest within the optical trap, or a presence of a plurality of particles of interest within the optical trap based on the detection signals. The detection signals have stochastic time variances due to Brownian motion of the particles of interest in suspension within the particle chamber, and the determination of the presence of the single particle or the presence of the plurality of particles is based on a dissimilarity of the stochastic time variance of the single particle relative to the plurality of particles. The automated additive manufacturing system also includes a three-axis translation stage in operative connection to the particle chamber. The particle chamber includes an assembly section therein, and the processor is further configured to direct the three-axis translation stage to translate a trapped single particle to a particle deposition position within the assembly section, and the processor is further configured to direct the optical source to release the trapped single particle at the particle deposition position.

A method of selecting a particle for automated additive manufacturing according to an embodiment of the current invention includes directing light from an optical source onto an objective lens, the light having a sufficient power and the objective lens having a sufficient numerical aperture to provide an optical trap for particles of interest, delivering the particles of interest to a particle chamber arranged to intercept focused light from the objective lens such that the optical trap is formed within the chamber, the chamber being suitable to contain the particles of interest in a suspension therein; detecting light from the optical source after being scattered by at least one particle when held within the optical trap and to provide detection signals; and receiving the detection signals by a processor, the processor being configured to determine at least one of an absence of particles of interest within the optical trap, a presence of a single particle of interest within the optical trap, or a presence of a plurality of particles of interest within the optical trap based on said detection signals. The detection signals have stochastic time variances due to Brownian motion of the particles of interest in suspension within the particle chamber, and the determination of the presence of the single particle or the presence of the plurality of particles is based on a dissimilarity of the stochastic time variance of the single particle relative to the plurality of particles.

### BRIEF DESCRIPTION OF THE DRAWINGS

FIG. 1 is a schematic illustration of particle selection system for an additive manufacturing system according to an embodiment of the current invention;

FIG. 2 is a schematic illustration of an exploded view of a particle chamber according to an embodiment of the current invention;

FIG. 3 is schematic illustration of a particle supply system connected to a particle chamber according to an embodiment of the current invention;

FIG. 4 is schematic illustration of a particle chamber that includes a particle search section and an assembly section along with a schematic representation of a search routine according to an embodiment of the current invention;

FIG. 5 is a flow chart illustrating automated particle selection according to an embodiment of the current invention;

FIG. 6 is schematic illustration of possible particles of interest according to an embodiment of the current invention;

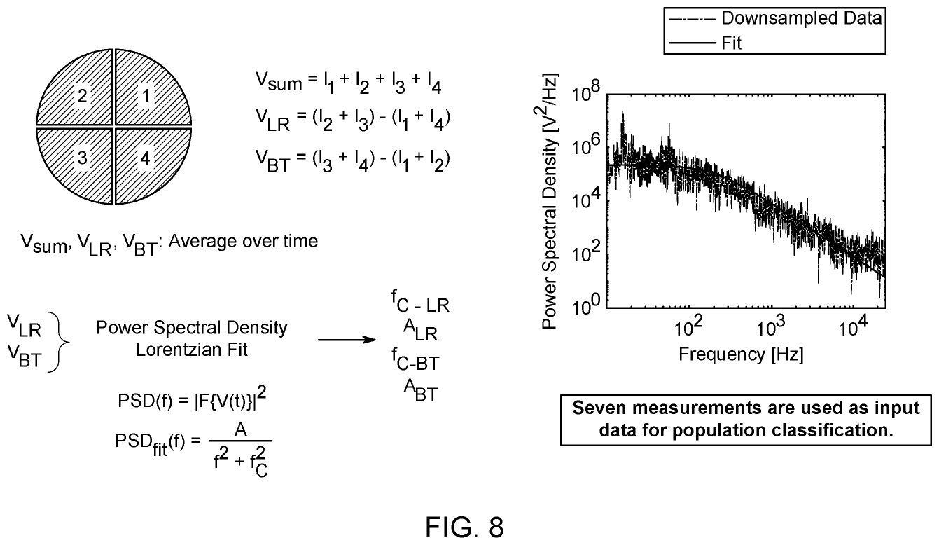

FIG. 7 is schematic illustration of light being detected according to an embodiment of the current invention;

FIG. 8 illustrates quadrant photodiode data collection and processing according to an embodiment of the current invention;

FIG. 9 illustrates principal component analysis and support vector machine according to an embodiment of the current invention;

FIGS. 10, 11A and 11B explain calibration accuracy according to an embodiment of the current invention;

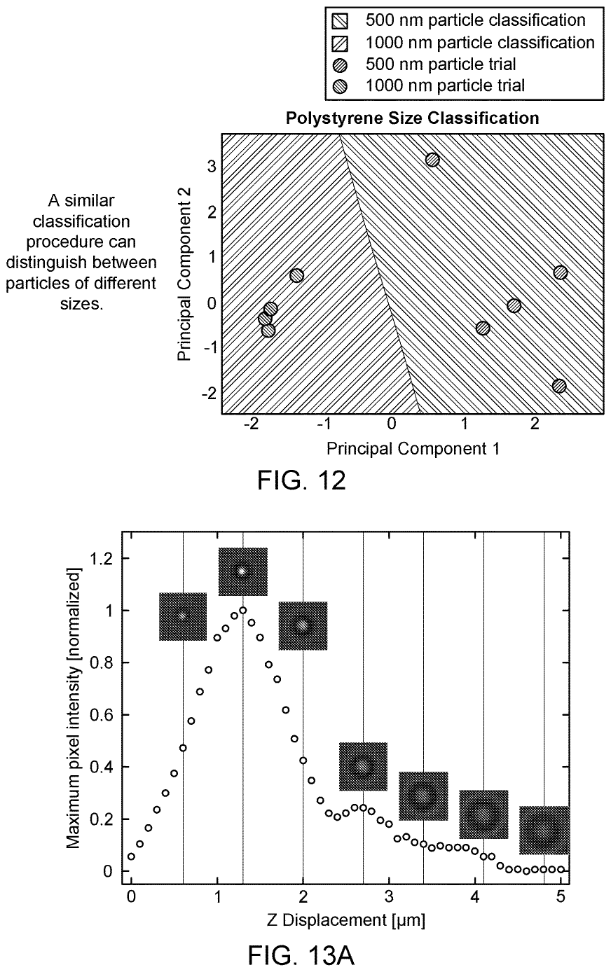

FIG. 12 shows an example of size classification according to an embodiment of the current invention;

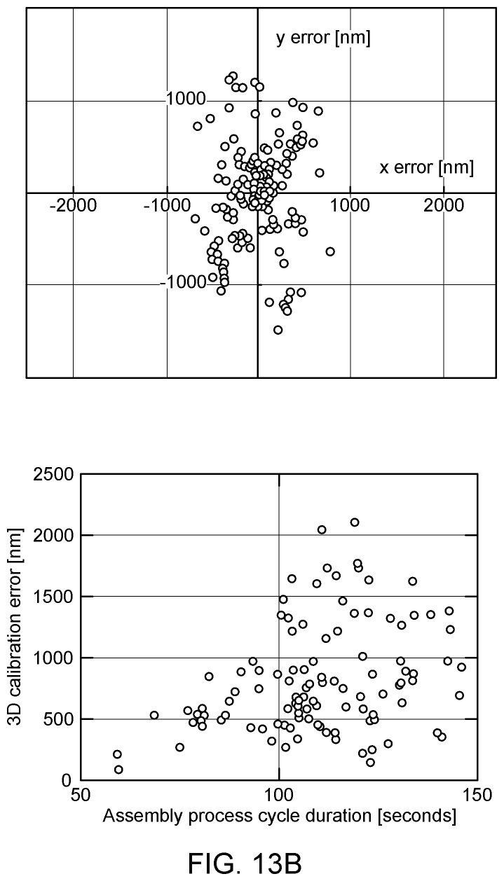

FIGS. 13A, 13B and 13C describe an automated additive manufacturing system according to an embodiment of the current invention;

FIG. 14 describes some concepts of positional accuracy of automated assembly according to an embodiment of the current invention;

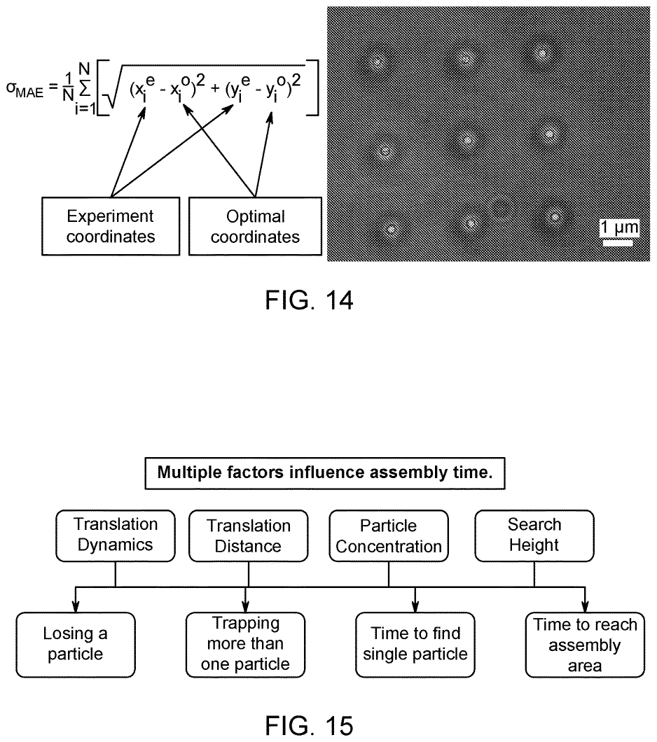

FIG. 15 describes some concepts for increasing efficiency of automated assembly according to an embodiment of the current invention;

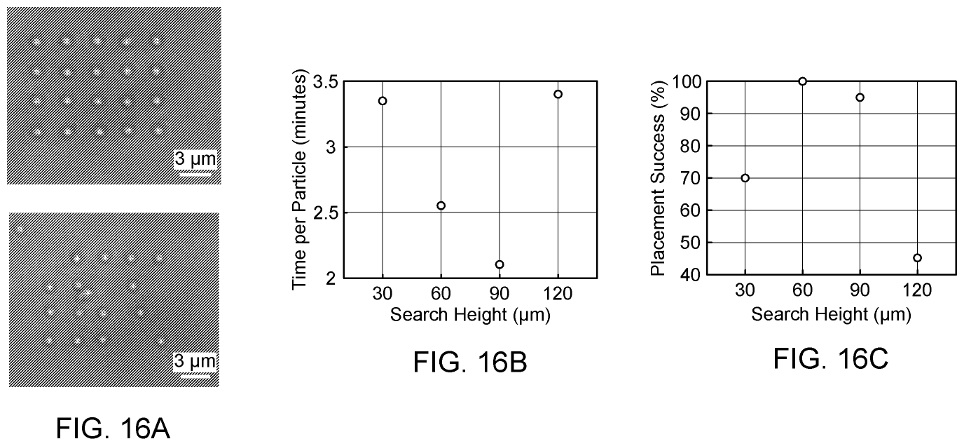

FIGS. 16A, 16B, and 16C describe some concepts for parameter optimization for automated assembly according to an embodiment of the current invention; and

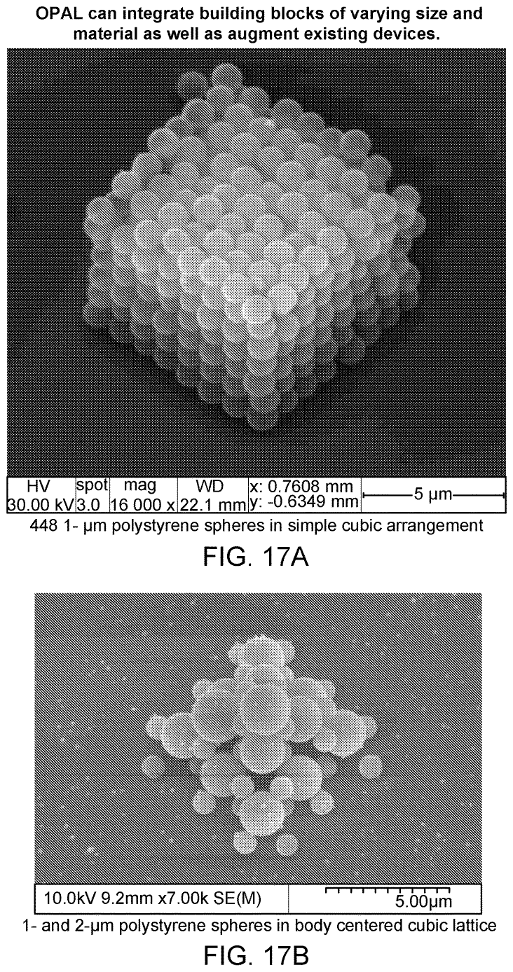

FIGS. 17A, 17B and 17C show some examples of structures assembled according to an embodiment of the current invention.

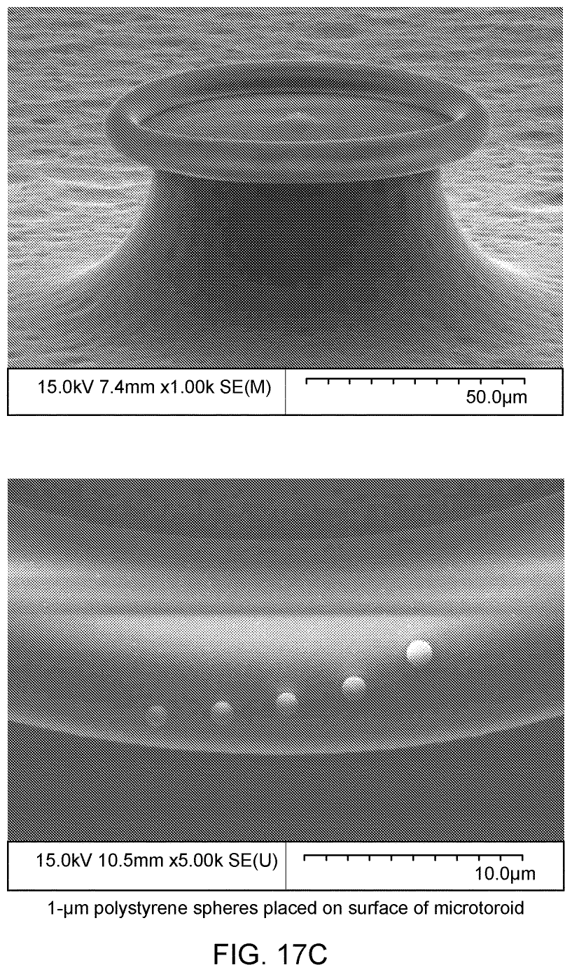

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

The term “light” is intended to have a broad definition that can include light in the visible as well as non-visible regions of the electromagnetic spectrum. For example, the term “light” can include, but is not limited to, visible, infrared and ultraviolet light. Similarly, the term “optical” has a corresponding broad definition as with the term “light”.

An embodiment of the current invention is directed to a method of fully automating the additive manufacturing approach using the back-scattered optical signal measured by a quadrant photodiode combined with principal component analysis and/or other machine learning techniques to ensure that a single particle of desired size is trapped. More specifically, the signal can be used to determine whether zero, one, or more than one particle of a given size are in the trap. If there are zero particles in the trap, the computer can execute a search pattern to try to find a particle to trap. As soon as one particle is in the trap, the computer can execute the next assembly step by bringing the particle to the desired location. If another particle enters the trap while this is happening, the computer can abort assembly, release the trap, and then go back to searching for a single particle to trap.

We have data showing that our classification approach is working, as shown in the examples below. This classification can be incorporated into our real-time assembly program. Some aspects of the current invention include: the use of a quadrant photodiode for determining whether there are zero, one, or more building blocks in an additive manufacturing staging area; more specifically in an optical tweezer based assembly approach; the use of machine learning to classify quadrant photodiode signals to classify building blocks; more specifically the use of principal component analysis; and specific approaches for how these analysis steps are incorporated into a real-time assembly program.

The presented accuracy for determining the number of trapped building blocks has been achieved using a two-step classification. The first classification determines if something is present in the optical trap; if the first classification indicates that something is present in the optical trap the subsequent classification determines if what is trapped is a single particle or more than one particle. This two-step method, as opposed to a single-step classification to determine between zero, one, or more than one building blocks, has achieved greater accuracy in real time.

We have data showing how the accuracy of classification depends on the difference between the z-coordinate where training data for the machine learning approach is acquired and the z-coordinate where real-time data is acquired. The training data used to generate the principal component transformation and machine learning models are taken at a specific z-coordinate (distance above assembly surface); deviation from this z-coordinate shifts the data acquired in real time within the principal component coordinate system and may result in real-time data crossing the decision line separating classes that is determined by machine learning. In the context of an automated additive manufacturing system, it is important to consider the z-coordinate from which the particle is received, as inaccuracies in these classifications can lead to defects in the desired structure if there is not a particle trapped or if there is more than one particle trapped.

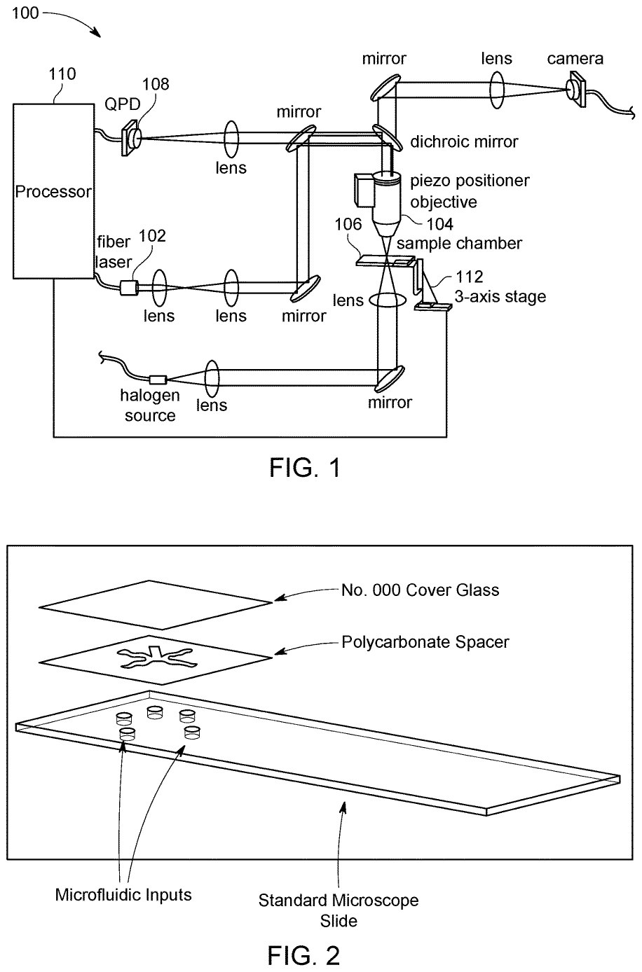

Accordingly, FIG. 1 provides a schematic illustration of a particle selection system 100 for an additive manufacturing system according to an embodiment of the current invention. The particle selection 100 includes an optical source 102 and an objective lens 104 arranged in an optical path of said optical source 102. The optical source 102 has sufficient power and the objective lens 104 has a sufficient numerical aperture to provide an optical trap for particles of interest. The optical source can be one of more lasers, for example. In the embodiment of FIG. 1, the optical source 102 is illustrated as a fiber laser, but the general concepts of the current invention are not limited to only that example.

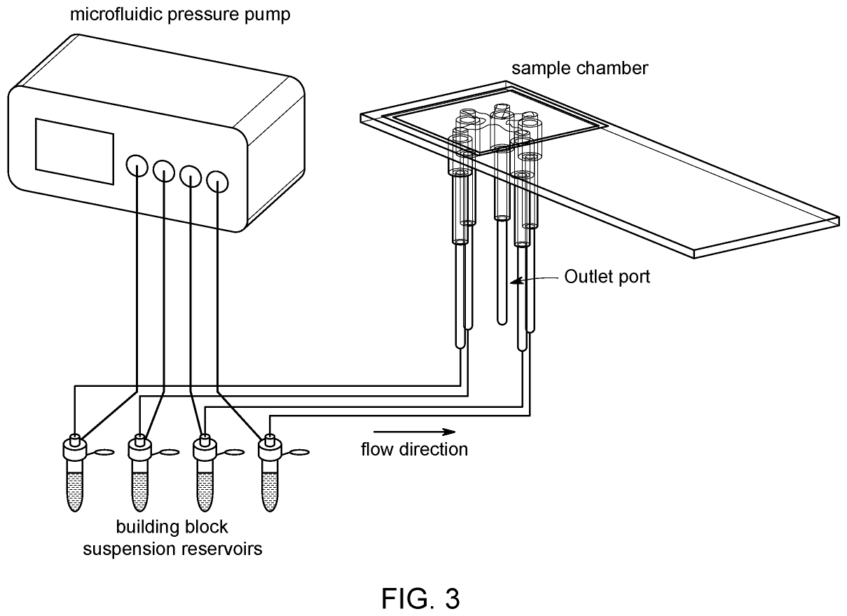

The particle selection 100 also includes a particle chamber 106 arranged to intercept focused light from the objective lens 104 such that the optical trap is formed within the particle chamber 106. The particle chamber 106 is suitable to contain the particles of interest in a suspension therein. The particle chamber 106 can be a microfluidic structure such as, but not limited to, the examples illustrated in FIGS. 2-4, for example. In those examples a microfluidic system can be provided to deliver particles of interest to the particle chamber 106.

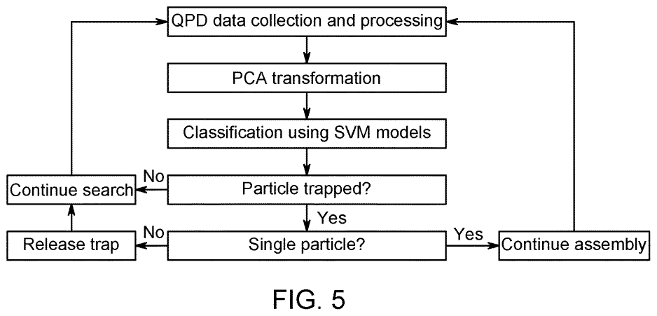

FIG. 4 is a schematic illustration of particles of interest in which particle and substrate surfaces can be functionalized to effect assembly. The general concepts of the current invention are not limited to only that example of particles and surface functionalization. A wide range of particle types can be used with or without one or more types of surface functionalization.

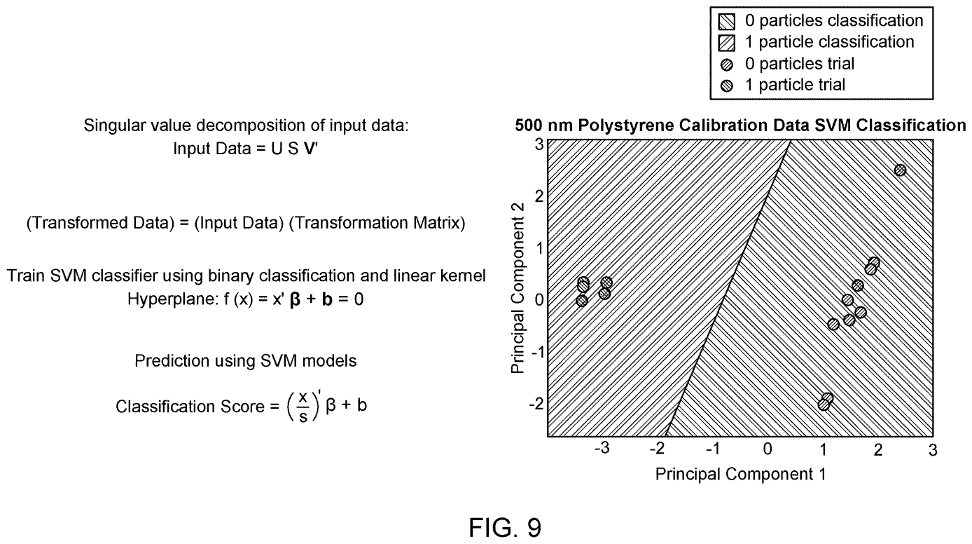

The particle selection 100 also includes an optical detector 108 arranged to receive light from the optical source 102 after being scattered by at least one particle when held within the optical trap and to provide detection signals. In the examples shown below, the optical detector 108 is a quadrant photodiode (QPD). FIG. 7 is a schematic illustration of a quadrant photodiode that has scattered light directed thereon. However, the general concepts of the current invention are not limited to only quadrant photodiodes for the optical detector 108. Photodiodes with more than or less than four sections, could be used for example. Another embodiment could utilize an imaging array for the optical detector 108, for example. The general concepts of the current invention are not limited to only these examples.

The particle selection 100 also includes a processor 110 arranged to receive the detection signals. The processor is configured to determine at least one of an absence of particles of interest within the optical trap, a presence of a single particle of interest within the optical trap, or a presence of a plurality of particles of interest within the optical trap based on the detection signals. The detection signals have stochastic time variances due to Brownian motion of the particles of interest in suspension within the particle chamber 106, and the determination of the presence of the single particle or the presence of the plurality of particles is based on a dissimilarity of the stochastic time variance of the single particle relative to the plurality of particles.

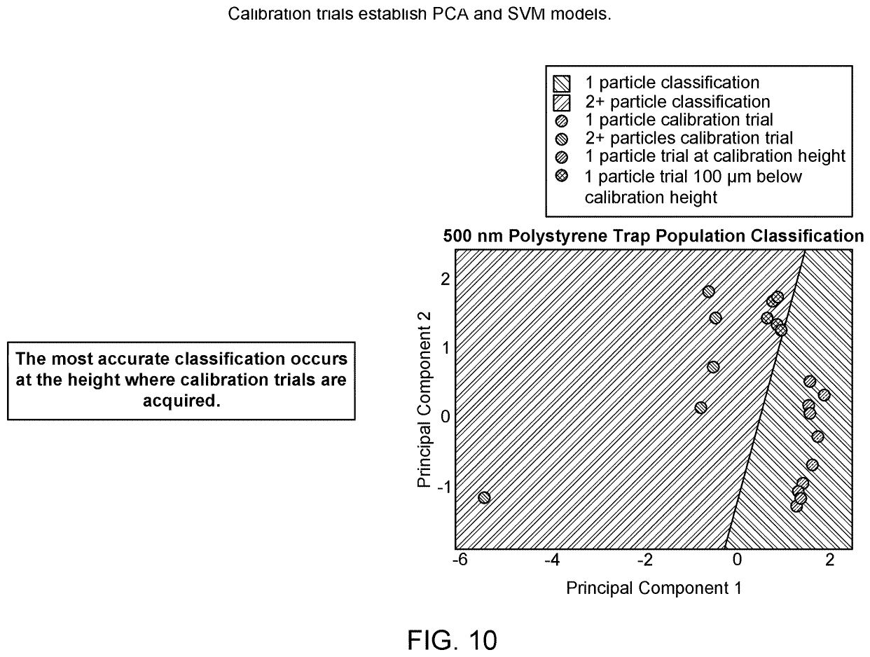

Particles in an optical trap exhibit Brownian motion, which depends on the strength of the trap as well as the size of the particle, among other parameters. The backscattered signal measured using the QPD provides a measurement of the Brownian motion as well as the overall strength of the backscattered light, which both correlate with the type, size, and number of objects in the optical trap. For example, larger objects tend to scatter more light, leading to greater average Vsum values, while smaller objects exhibit faster Brownian motion, corresponding to higher corner frequencies in the power spectral densities of the V_LR and V_BT signals, as defined in FIG. 8. The example of a power spectrum to the right in FIG. 8 can be thought as a Fourier transform or detection signals, thus transforming from the time domain to the frequency domain. In FIG. 8, one can see the fit to the spectral density has a relatively flat portion that bend downward above a certain spectral frequency, which is referred to above as the “corner frequency”. The fits to spectral densities can move up or down as well as flatten or sharpen, depending on the size and/or number of particles in the trap, for example. In some embodiments, the use of particles that are equal in size at least to a desired variance, can be added information in distinguishing between a single trapped particle and a plurality of trapped particles.

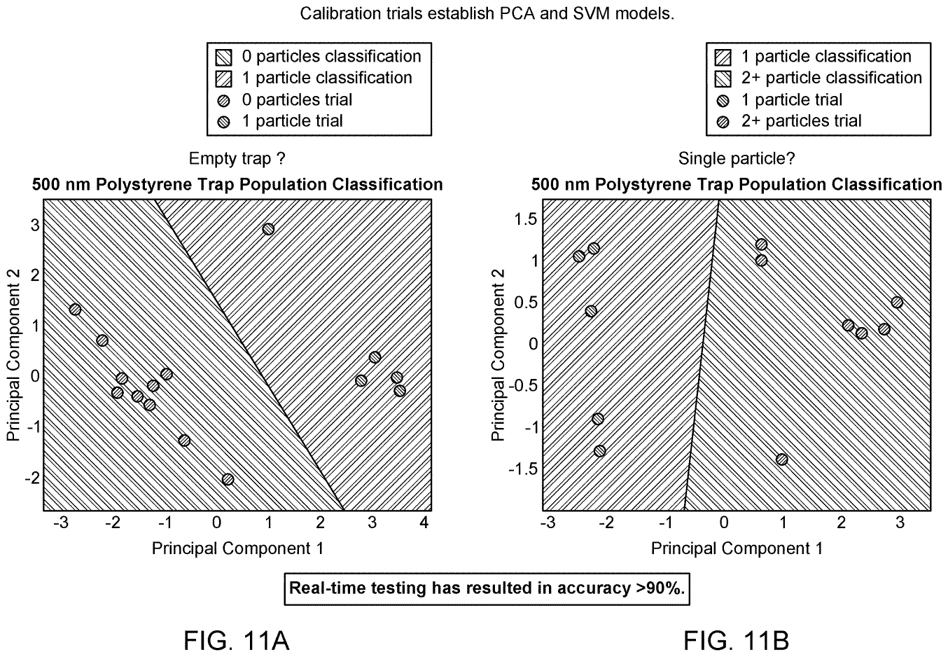

Rather than attempting to develop a complete physical model for how the number and type of objects in the optical trap affect all aspects of the QPD signal, we instead use a machine learning approach according to some embodiments of the current invention, where we preprocess the raw QPD signal to pull out averages and standard deviations of the mean signals and corner frequencies, and then use principal component analysis (PCA) to determine a linear transformation that combines this preprocessed data into just two values that best discriminate among different trap states. These two values are referred to as the first two principal components. Possible trap states include an empty trap, a trap with a single particle, or a trap with multiple particles. Finally, according to some embodiments of the current invention, we use a support vector machine (SVM) approach to draw thresholds where the principal component values on one side of the threshold correspond to one trap state, while the principal component values on the other side of the threshold correspond to another trap state (FIG. 9).

According, in some embodiments, the processor 110 is further configured to determine a size of the single particle when the single particle is held within the optical trap based on a characteristic of the stochastic time variances.

In some embodiments, processor 110 is further configured to first determine one of an absence of particles within the optical trap or the presence of a single particle or plurality of particles within the optical trap, followed by determining whether the at least one particle when present is a single particle or a plurality of particles.

In some embodiments, the processor 110 is further configured to extract averages and standard deviations of summed signals and corner frequencies from a spectral distribution of the detection signals.

In some embodiments, the processor 110 is further configured to perform a machine learning analysis where the inputs are said extracted averages and standard deviations of sum signals and corner frequencies and the outputs are predicted trap states, wherein said different trap states comprise no trapped particles, a single trapped particle and a plurality of trapped particles.

In some embodiments, the processor 110 is further configured to receive training data for a selected z coordinate for performing the machine learning analysis.

In some embodiments, the machine learning analysis is based on a principal component analysis on the detection signals to determine a linear transformation that combines the extracted averages and standard deviations of summed signals and corner frequencies into two principal component values that best discriminate among different trap states. The different trap states include, but are not limited to, no trapped particles, a single trapped particle and a plurality of trapped particles.

In some embodiments, the processor 110 is further configured to perform a support vector machine approach to establish a threshold for the two principal component values such that on one side of the threshold, the two principal component values correspond to one trap state, while the two principal component values on the other side of the threshold correspond to another trap state.

In some embodiments, the particle selection system 100 further includes a three-axis translation stage 112 in operative connection to the particle chamber 106. In the embodiment of FIG. 1, the z-axis is aligned up and down in the figure.

In some embodiments, the processor 110 is further configured to perform a search routine during a particle trapping procedure. FIG. 4 is a schematic illustration of one possible search routine in one possible particle chamber is which there is a search section connected to a displaced assembly section. However, the general concepts of the current invention are not limited to that search routine or to the illustrated particle chamber.

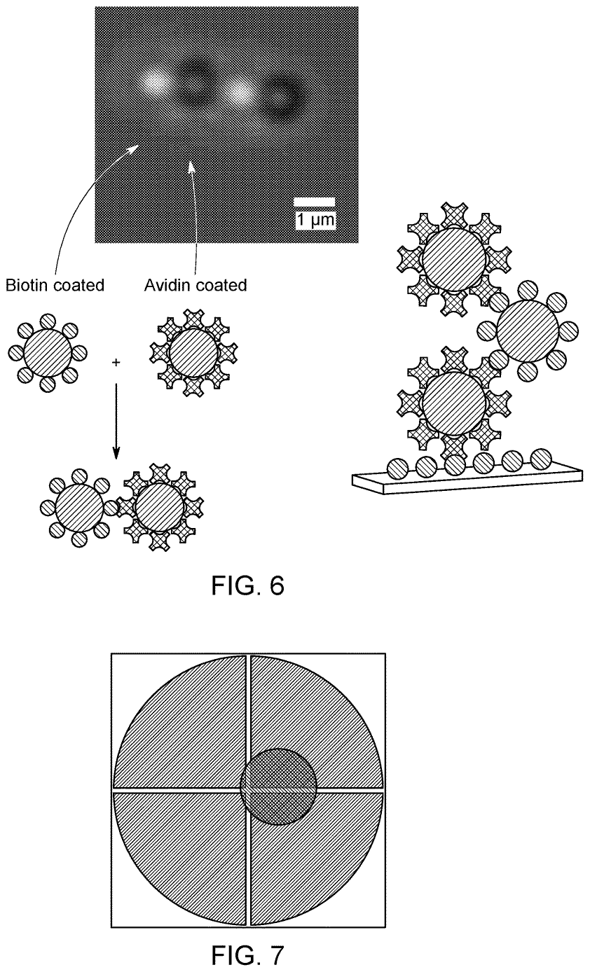

In some embodiments, the processor 110 is further configured to cause the optical trap to release particles when a plurality of particles is detected and to perform the search routine subsequent to the release. See FIG. 5 for an example of possible work flow according to an embodiment of the current invention.

In some embodiments, the processor 110 is further configured to translate a single trapped particle to an assembly location after detecting a single particle of interest is trapped.

In some embodiments, the particles of interest each have a maximum dimension less than 1 micrometer.

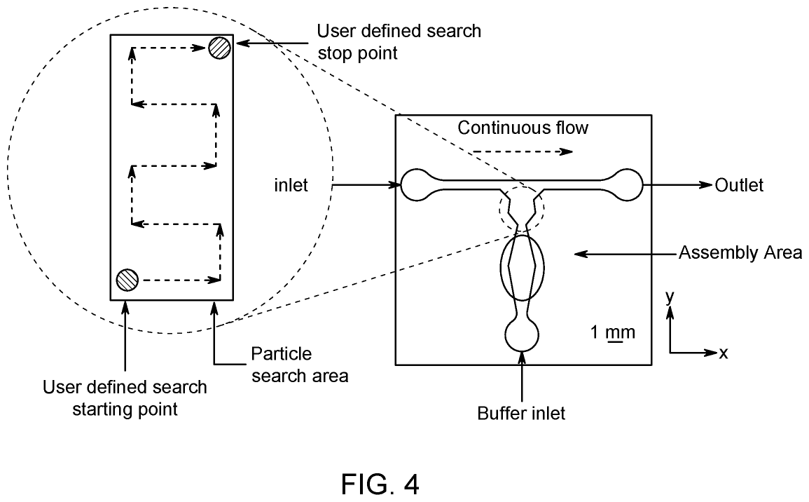

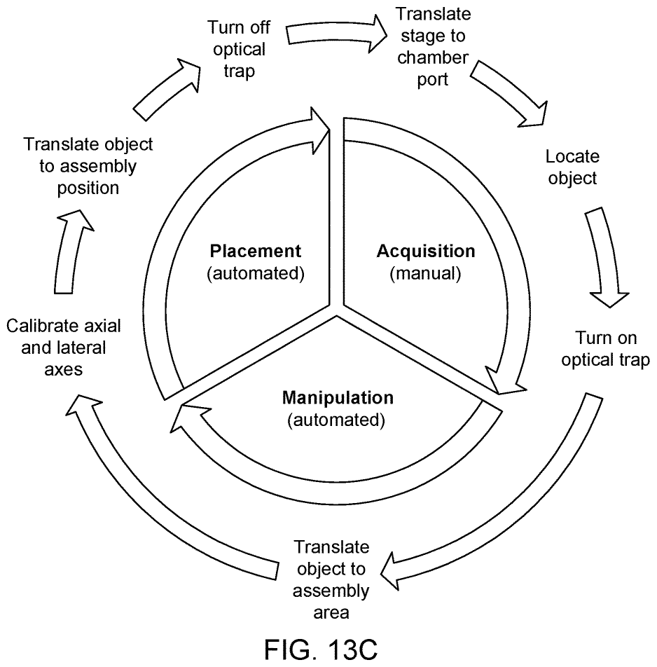

In some embodiments, an automated additive manufacturing system can include the particle selection system 100. This is illustrated schematically in FIG. 13C in which the particle selection system 100 replaces the manual selection system. The automated additive manufacturing system can include a microfluidic particle supply system such as, but not limited to, the example system illustrated in FIG. 3.

According to some embodiments, method of selecting a particle for automated additive manufacturing includes directing light from an optical source onto an objective lens, the light having a sufficient power and the objective lens having a sufficient numerical aperture to provide an optical trap for particles of interest; delivering the particles of interest to a particle chamber arranged to intercept focused light from the objective lens such that the optical trap is formed within the chamber, the chamber being suitable to contain the particles of interest in a suspension therein; detecting light from the optical source after being scattered by at least one particle when held within the optical trap and to provide detection signals; and receiving the detection signals by a processor, the processor being configured to determine at least one of an absence of particles of interest within the optical trap, a presence of a single particle of interest within the optical trap, or a presence of a plurality of particles of interest within the optical trap based on the detection signals. The detection signals have stochastic time variances due to Brownian motion of the particles of interest in suspension within the particle chamber, and the determination of the presence of the single particle or the presence of the plurality of particles is based on a dissimilarity of the stochastic time variance of the single particle relative to the plurality of particles.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A particle selection system for an additive manufacturing system, comprising:
an optical source;
an objective lens arranged in an optical path of said optical source, said optical source having a sufficient power and said objective lens having a sufficient numerical aperture to provide an optical trap for particles of interest;
a particle chamber arranged to intercept focused light from said objective lens such that said optical trap is formed within said chamber, said chamber being suitable to contain said particles of interest in a suspension therein;
an optical detector arranged to receive light from said optical source after being scattered by at least one particle when held within said optical trap and to provide detection signals; and
a processor arranged to receive said detection signals, said processor being configured to determine at least one of an absence of particles of interest within said optical trap, a presence of a single particle of interest within said optical trap, or a presence of a plurality of particles of interest within said optical trap based on said detection signals,
wherein said detection signals have stochastic time variances due to Brownian motion of said particles of interest in suspension within said particle chamber, and
wherein said determination of said presence of said single particle or said presence of said plurality of particles is based on a dissimilarity of said stochastic time variance of said single particle relative to said plurality of particles.

2. The particle selection system according to claim 1, wherein said processor is further configured to determine a size of said single particle when said single particle is held within said optical trap based on a characteristic of said stochastic time variances.

3. The particle selection system according to claim 1, wherein said processor is further configured to first determine one of an absence of particles within said optical trap or the presence of a single particle or plurality of particles within said optical trap, followed by determining whether said at least one particle when present is a single particle or a plurality of particles.

4. The particle selection system according to claim 1, wherein said processor is further configured to extract averages and standard deviations of summed signals and corner frequencies from a spectral distribution of said detection signals.

5. The particle selection system according to claim 4, wherein said processor is further configured to perform a machine learning analysis where the inputs are said extracted averages and standard deviations of sum signals and corner frequencies and the outputs are predicted trap states, wherein said different trap states comprise no trapped particles, a single trapped particle and a plurality of trapped particles.

6. The particle selection system according to claim 5, wherein said processor is further configured to receive training data for a selected z coordinate for performing said machine learning analysis.

7. The particle selection system according to claim 5, wherein said machine learning analysis is based on a principal component analysis on said detection signals to determine a linear transformation that combines said extracted averages and standard deviations of summed signals and corner frequencies into two principle component values that best discriminate among different trap states, wherein said different trap states comprise no trapped particles, a single trapped particle and a plurality of trapped particles.

8. The particle selection system according to claim 6, wherein said processor is further configured to perform a support vector machine approach to establish a threshold for the two principal component values such that on one side of the threshold, the two principal component values correspond to one trap state, while the two principal component values on the other side of the threshold correspond to another trap state.

9. The particle selection system according to claim 1, further comprising a three-axis translation stage in operative connection to said particle chamber.

10. The particle selection system according to claim 9, wherein said processor is further configured to perform a search routine during a particle trapping procedure.

11. The particle selection system according to claim 10, wherein said processor is further configured to cause said optical trap to release particles when a plurality of particles is detected and to perform said search routine subsequent to said release.

12. The particle selection system according to claim 11, wherein said processor is further configured to translate a single trapped particle to an assembly location after detecting a single particle of interest is trapped.

13. The particle selection system according to claim 1, wherein said optical detector comprises a quadrant photodiode arranged to detect backscattered light from said optical source after being backscattered by at least one particle when held within said optical trap.

14. The particle selection system according to claim 1, wherein said particle has a maximum dimension less than 1 micrometer.

15. An automated additive manufacturing system, comprising:
a particle supply system;
a particle selection system in fluid connection to said particle supply system, said particle selection system comprising:
an optical source,
an objective lens arranged in an optical path of said optical source, said optical source having a sufficient power and said objective lens having a sufficient numerical aperture to provide an optical trap for particles of interest,
a particle chamber arranged to intercept focused light from said objective lens such that said optical trap is formed within said chamber, said chamber being suitable to receive said particles of interest from said fluid supply system and to contain said particles of interest in a suspension therein,
an optical detector arranged to receive light from said optical source after being scattered by at least one particle when held within said optical trap and to provide detection signals, and
a processor arranged to receive said detection signals, said processor being configured to determine at least one of an absence of particles of interest within said optical trap, a presence of a single particle of interest within said optical trap, or a presence of a plurality of particles of interest within said optical trap based on said detection signals,
wherein said detection signals have stochastic time variances due to Brownian motion of said particles of interest in suspension within said particle chamber, and
wherein said determination of said presence of said single particle or said presence of said plurality of particles is based on a dissimilarity of said stochastic time variance of said single particle relative to said plurality of particles; and
a three-axis translation stage in operative connection to said particle chamber,
wherein said particle chamber comprises an assembly section therein, and
wherein said processor is further configured to direct said three-axis translation stage to translate a trapped single particle to a particle deposition position within said assembly section, and
wherein said processor is further configured to direct said optical source to release said trapped single particle at said particle deposition position.

16. The automated additive manufacturing system according to claim 15, wherein said processor is further configured to determine a size of said single particle when said single particle is held within said optical trap based on a characteristic of said stochastic time variances.

17. The automated additive manufacturing system according to claim 15, wherein said processor is further configured to first determine one of an absence of particles within said optical trap or the presence of a single particle or plurality of particles within said optical trap, followed by determining whether said at least one particle when present is a single particle or a plurality of particles.

18. The automated additive manufacturing system according to claim 15, wherein said processor is further configured to extract averages and standard deviations of summed signals and corner frequencies from a spectral distribution of said detection signals.

19. The automated additive manufacturing system according to claim 18, wherein said processor is further configured to perform a machine learning analysis where the inputs are said extracted averages and standard deviations of sum signals and corner frequencies and the outputs are predicted trap states, wherein said different trap states comprise no trapped particles, a single trapped particle and a plurality of trapped particles.

20-28. (canceled)

29. A method of selecting a particle for automated additive manufacturing, comprising:
directing light from an optical source onto an objective lens, said light having a sufficient power and said objective lens having a sufficient numerical aperture to provide an optical trap for particles of interest;
